(19) United States
(12) Patent Application Publication
(10) Pub. No.: US 2005/0052427 A1
(43) Pub. Date: Mar. 10, 2005

(54) Hand gesture interaction with touch surface

(76) Inventors: Michael Chi Hung Wu, Vancouver (CA); Chia Shen, Lexington, MA (US); Kathleen Ryall, Cambridge, MA (US); Clifton Lloyd Forlines, Cambridge, MA (US)

Correspondence Address: Patent Department;Mitsubishi Electric Research Laboratories, Inc., 201 Broadway, Cambridge, MA, 02139, US

(21) Appl. No.: 10/659,180

(22) Filed: Sep. 10, 2003

(51) Int. Cl. G09G 5/00

(52) U.S. Cl. 345/173

(57) ABSTRACT

The invention provides a system and method for recognizing different hand gestures made by touching a touch sensitive surface. The gestures can be made by one finger, two fingers, more than two fingers, one hand and two hands. Multiple users can simultaneously make different gestures. The gestures are used to control computer operations. The system measures an intensity of a signal at each of an mxn array of touch sensitive pads in the touch sensitive surface. From these signal intensities, a number of regions of contiguous pads touched simultaneously by a user is determined. An area of each region is also determined. A particular gesture is selected according to the number of regions and the area of each region.

### FIELD OF THE INVENTION

This invention relates generally to touch sensitive surfaces, and more particularly to using touch surfaces to recognize and act upon hand gestures made by touching the surface.

### BACKGROUND OF THE INVENTION

Recent advances in sensing technology have enabled increased expressiveness of freehand touch input, see Ringel et al., “Barehands: Implement-free interaction with a wall-mounted display,” Proc CHI 2001, pp. 367-368, 2001, and Rekimoto “SmartSkin: an infrastructure for freehand manipulation on interactive surfaces,” Proc CHI 2002, pp. 113-120, 2002.

A large touch sensitive surface presents some new issues that are not present with traditional touch sensitive devices. Any touch system is limited by its sensing resolution. For a large surface, the resolution can be considerably lower that with traditional touch devices. When each one of multiple users can simultaneously generate multiple touches, it becomes difficult to determine a context of the touches. This problem has been addressed, in part, for single inputs, such as for mouse-based and pen-based stroke gestures, see André et al., “Paper-less editing and proofreading of electronic documents,” Proc. EuroTeX, 1999, Guimbretiere et al., “Fluid Interaction with high-resolution wall-size displays. Proc. UIST 2001, pp. 21-30, 2001, Hong et al., “SATIN: A toolkit for informal ink-based applications,” Proc. UIST 2000, pp. 63-72, 2001, Long et al., “Implications for a gesture design tool,” Proc. CHI 1999, pp. 40-47, 1999, and Moran et al., “Pen-based interaction techniques for organizing material on an electronic whiteboard,” Proc. UIST 1997, pp. 45-54, 1992.

The problem becomes more complicated for hand gestures, which are inherently imprecise and inconsistent. A particular hand gesture for a particular user can vary over time. This is partially due to the many degrees of freedom in the hand. The number of individual hand poses is very large. Also, it is physically demanding to maintain the same hand pose over a long period of time.

Machine learning and tracking within vision-based systems have been used to disambiguate hand poses. However, most of those systems require discrete static hand poses or gestures, and fail to deal with highly dynamic hand gestures, Cutler et al., “Two-handed direct manipulation on the responsive workbench,” Proc 13D 1997, pp. 107-114, 1997, Koike et al., “Integrating paper and digital information on EnhancedDesk,” ACM Transactions on Computer-Human Interaction, 8 (4), pp. 307-322, 2001, Krueger et al., “VIDEOPLACE—An artificial reality, Proc CHI 1985, pp. 35-40, 1985, Oka et al., “Real-time tracking of multiple fingertips and gesture recognition for augmented desk interface systems,” Proc FG 2002, pp. 429-434, 2002, Pavlovic et al., “Visual interpretation of hand gestures for human-computer interaction: A review,” IEEE Transactions on Pattern Analysis and Machine Intelligence, 19 (7). pp. 677-695, 1997, and Ringel et al., “Barehands: Implement-free interaction with a wall-mounted display,” Proc CHI 2001, pp. 367-368, 2001. Generally, camera-based systems are difficult and expensive to implement, require extensive calibration, and are typically confined to controlled settings.

Another problem with an interactive touch surface that also displays images is occlusion. This problem has been addressed for single point touch screen interaction, Sears et al., “High precision touchscreens: design strategies and comparisons with a mouse,” International Journal of Man-Machine Studies, 34 (4). pp. 593-613, 1991 and Albinsson et al., “High precision touch screen interaction,” Proc CHI 2003, pp. 105-112, 2003. Pointers have been used to interact with wall-based display surfaces, Myers et al., “Interacting at a distance: Measuring the performance of laser pointers and other devices,” Proc. CHI 2002, pp. 33-40, 2002.

It is desired to provide a gesture input system for a touch sensitive surface that can recognize multiple simultaneous touches by multiple users.

### SUMMARY OF THE INVENTION

It is an object of the invention to recognize different hand gestures made by touching a touch sensitive surface.

It is desired to recognize gestures made by multiple simultaneous touches.

It is desired to recognize gestures made by multiple users touching a surface simultaneously.

A method according to the invention recognizes hand gestures. An intensity of a signal at touch sensitive pads of a touch sensitive surface is measured. The number of regions of contiguous pads touched simultaneously is determined from the intensities of the signals. An area of each region is determined. Then, a particular gesture is selected according to the number of regions touched and the area of each region.

### BRIEF DESCRIPTION OF THE DRAWINGS

FIG. 1 is a block diagram of a touch surface for recognizing hand gestures according to the invention;

FIG. 2A is a block diagram of a gesture classification process according to the invention;

FIG. 2B is a flow diagram of a process for performing gesture modes;

FIG. 3 is a block diagram of a touch surface and a displayed bounding box;

FIG. 4 is a block diagram of a touch surface and a displayed bounding circle; and

FIGS. 5-9 are examples hand gestures recognized by the system according to the invention.

### DETAILED DESCRIPTION OF THE PREFERRED EMBODIMENT

The invention uses a touch surface to detect hand gestures, and to perform computer operations according to the gestures. We prefer to use a touch surface that is capable of recognizing simultaneously multiple points of touch from multiple users, see Dietz et al., “DiamondTouch: A multi-user touch technology,” Proc. User Interface Software and Technology (UIST) 2001, pp. 219-226, 2001, and U.S. Pat. No. 6,498,590 “Multi-user touch surface,” issued to Dietz et al., on Dec. 24, 2002, incorporated herein by reference. This touch surface can be made arbitrarily large, e.g., the size of a tabletop. In addition, it is possible to project computer generated images on the surface during operation.

By gestures, we mean moving hands or fingers on or across the touch surface. The gestures can be made by one or more fingers, by closed fists, or open palms, or combinations thereof. The gestures can be performed by one user or multiple simultaneous users. It should be understood that other gestures than the example gestures described herein can be recognized.

The general operating framework for the touch surface is described in U.S. patent application Ser. No. 10/053,652 “Circular Graphical User Interfaces” filed by Vernier et al., on Jan. 18 2002, incorporated herein by reference. Single finger touches can be reserved for traditional mouse-like operations, e.g., point and click, select, drag, and drop, as described in the Vernier application.

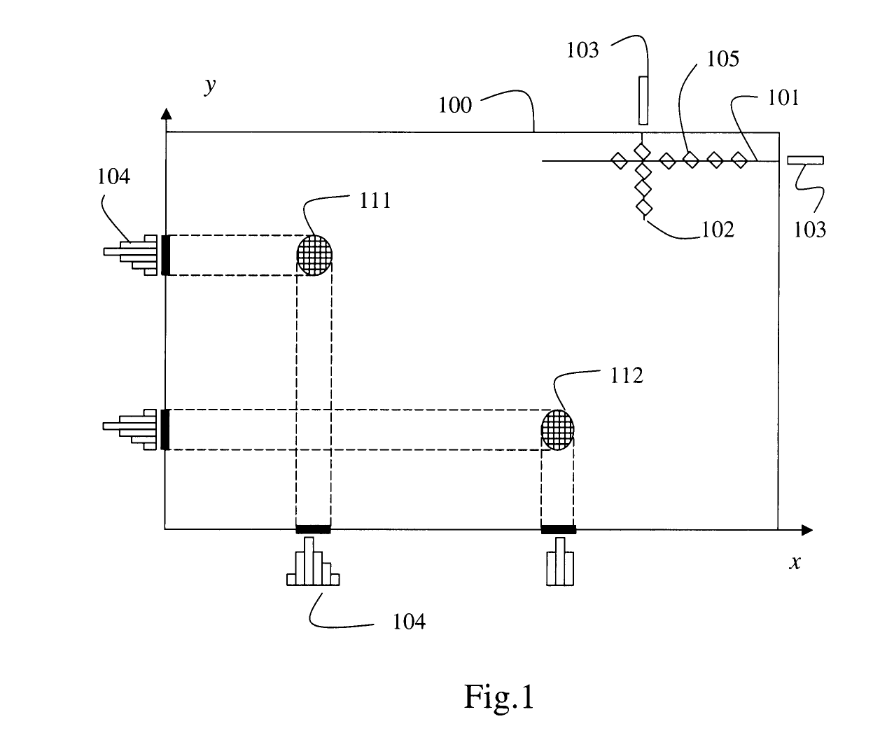

FIG. 1 is used to describe the details of operation of the invention. A touch surface 100 includes m rows 101 and n columns 102 of touch sensitive pads 105, shown enlarged for clarity. The pads are diamond-shaped to facilitate the interconnections. Each pad is in the form of an antenna that couples capacitively to a user when touched, see Dietz above for details. The signal intensity of a single pad can be measured.

Signal intensities 103 of the coupling can be read independently for each column along the x-axis, and for each row along the y-axis. Touching more pads in a particular row or column increases the signal intensity for that row or column. That is, the measured signal is proportional to the number of pads touched. It is observed that the signal intensity is generally greater in the middle part of a finger touch because of a better coupling. Interestingly, the coupling also improves by applying more pressure, i.e., the intensity of the signal is coarsely related to touching pressure.

The rows and columns of antennas are read along the x- and y-axis at a fixed rate, e.g., 30 frames/second, and each reading is presented to the software for analysis as a single vector of intensity values (x₀, x₁, . . . , xₘ, Y₀, Y₁, . . . , yₙ), for each time step. The intensity values are thresholded to discard low intensity signals and noise.

In FIG. 1, the bold line segments indicate the corresponding x and y coordinates of the columns and rows, respectively that have intensities 104 corresponding to touching. In the example shown, two fingers 111-112 touch the surface. The signal intensities of contiguously touched rows of antennas are summed, as are signals of contiguously touched columns. This enables one to determine the number of touches, and an approximate area of each touch. It should be noted that in the prior art, the primary feedback data are x and y coordinates, i.e., a location of a zero dimensional point. In contrast, the primary feedback is a size of an area of a region touched. In addition, a location can be determined for each region, e.g., the center of the region, or the median of the intensities in the region.

Finger touches are readily distinguishable from a fist, and an open hand. For example, a finger touch has relatively high intensity values concentrated over a small area, while a hand touch generally has lower intensity values spread over a larger area.

For each frame, the system determines the number of regions. For each region, determine an area and location. The area is determined from an extent (x_{low}, x_{high}, y_{low}, x_{high}) of the corresponding intensity values 104. This information also indicates where the surface was touched. A total signal intensity is also determined for each region. The total intensity is the sum of the thresholded intensity values for the region. A time is also associated with each frame. Thus, each touched region is described by area, location, intensity, and time. The frame summary is stored in a hash table, using a time-stamp as a hash key. The frame summaries can be retrieved at a later time.

The frame summaries are used to determine a trajectory of each region. The trajectory is a path along which the region moves. A speed of movement and a rate of change of speed (acceleration) along each trajectory can also be determined from the time-stamps. The trajectories are stored in another hash table.

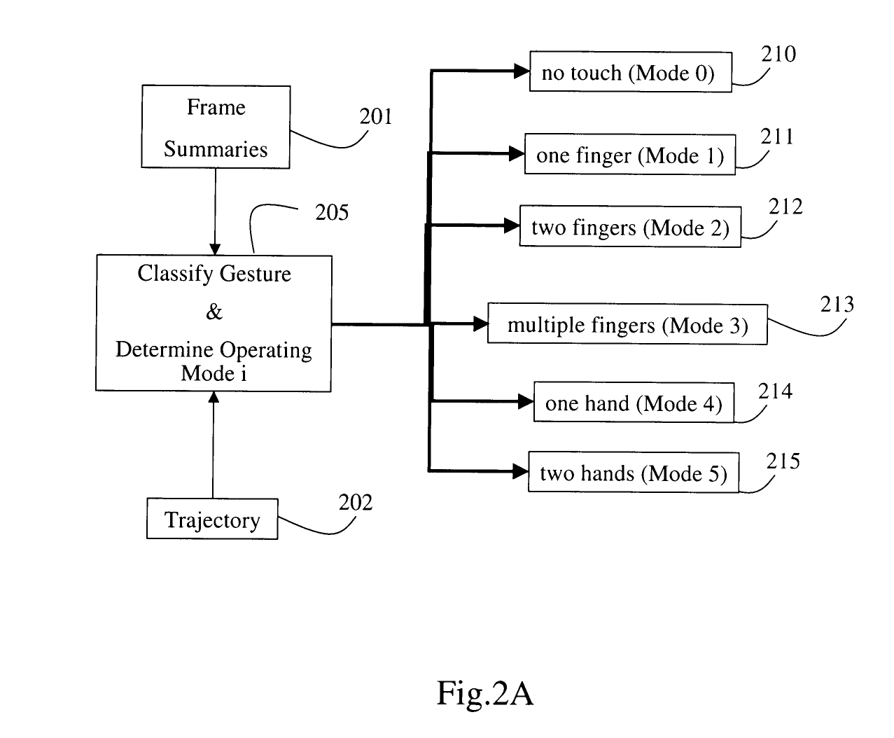

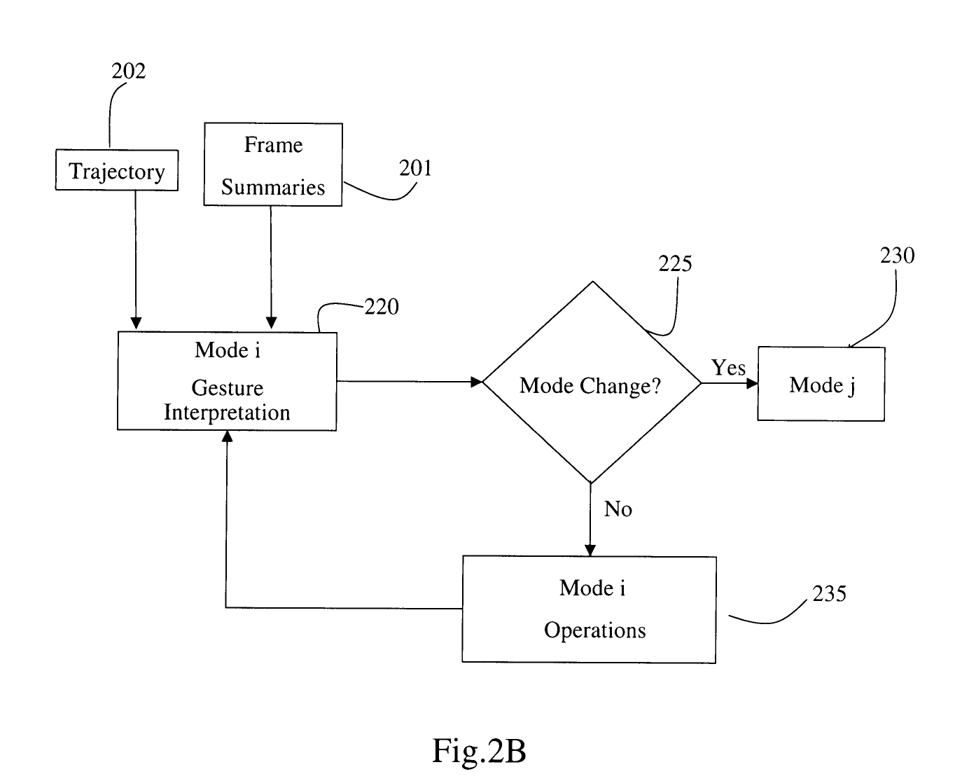

As shown in FIG. 2A, the frame summaries 201 and trajectories 202 are used to classify gestures and determine operating modes 205. It should be understood that a large number of different unique gestures are possible. In a simple implementation, the basic gestures are no-touch 210, one finger 211, two fingers 212, multi-finger 213, one hand 214, and two hands 215. These basic gestures are used as the definitions of the start of an operating mode i, where i can have values 0 to 5 (210-215).

For classification, it is assumed that the initial state is no touch, and the gesture is classified when the number of regions and the frame summaries remain relatively constant for a predetermined amount of time. That is, there are no trajectories. This takes care of the situation where not all fingers or hands reach the surface at exactly the same time to indicate a particular gesture. Only when the number of simultaneously touched regions remains the same for a predetermined amount of time is the gesture classified.

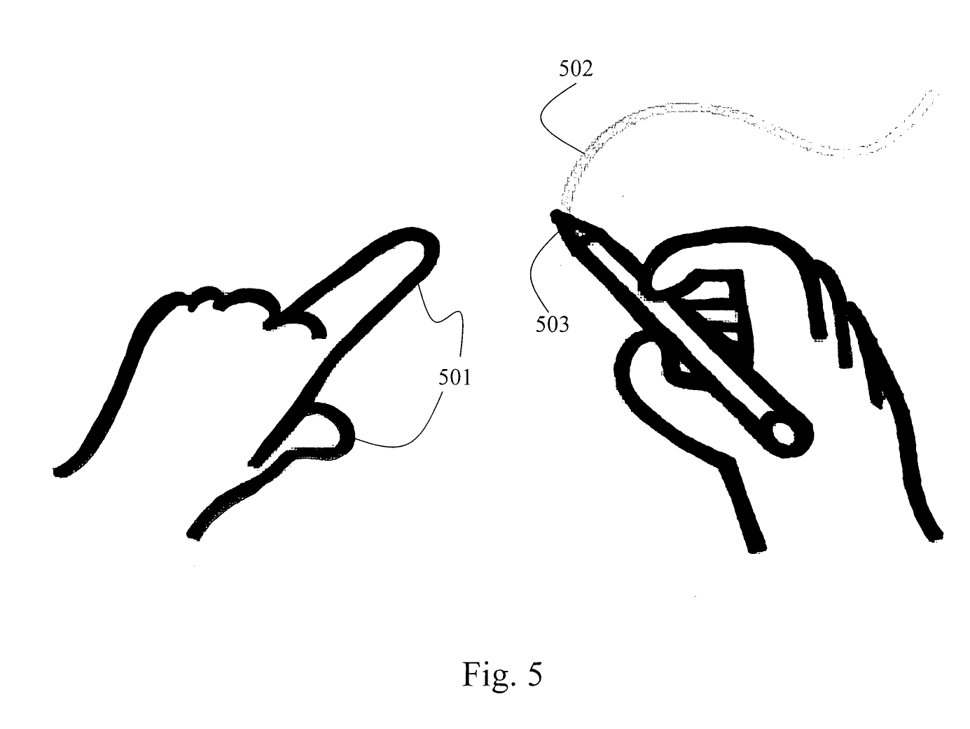

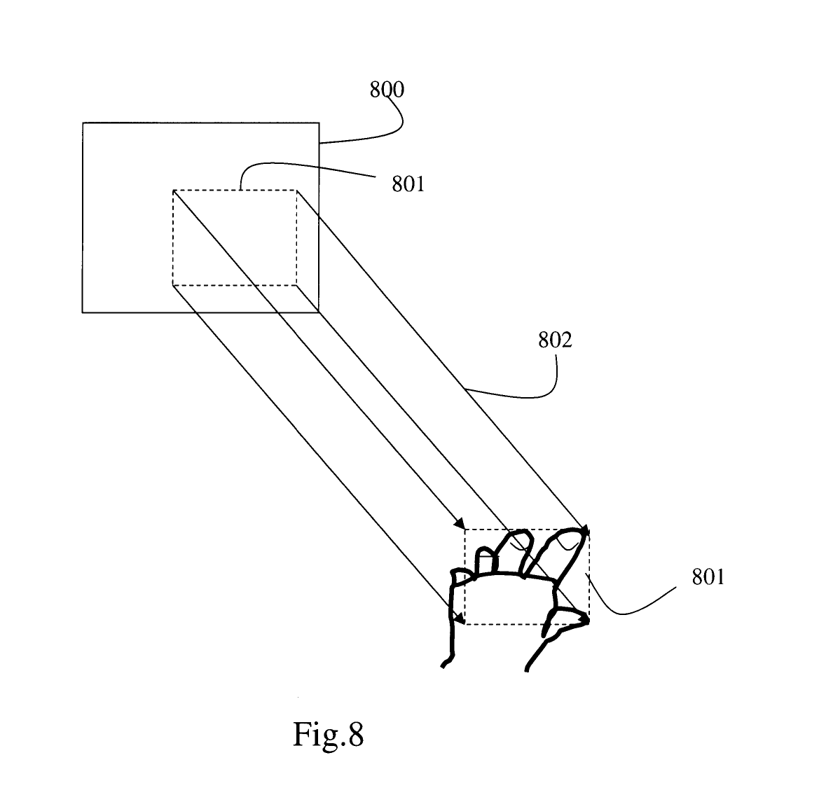

After the system enters a particular mode i after gesture classification as shown in FIG. 2A, the same gestures can be reused to perform other operations. As shown in FIG. 2B, while in mode i, the frame summaries 201 and trajectories 202 are used to continuously interpret 220 gestures as the fingers and hands are moving and touching across the surface. This interpretation is sensitive to the context of the mode. That is, depending on the current operating mode, the same gesture can generate either a mode change 225 or different mode operations 235. For example, a two-finger gesture in mode 2 can be interpreted as the desire to annotate a document, see FIG. 5, while the same two-finger gesture in mode 3 can be interpreted as controlling the size of a selection box, as shown in FIG. 8.

It should be noted that the touch surface as described here enables a different type of feedback than typical prior art touch and pointing devices. In the prior art, the feedback is typically based on the x and y coordinates of a zero-dimensional point. The feedback is often displayed as a cursor, pointer, or cross. In contrast, the feedback according to the invention can be area based, and in addition pressure or signal intensity based. The feedback can be displayed as the actual area touched, or a bounding perimeter, e.g., circle or rectangle. The feedback also indicates that a particular gesture or operating mode is recognized.

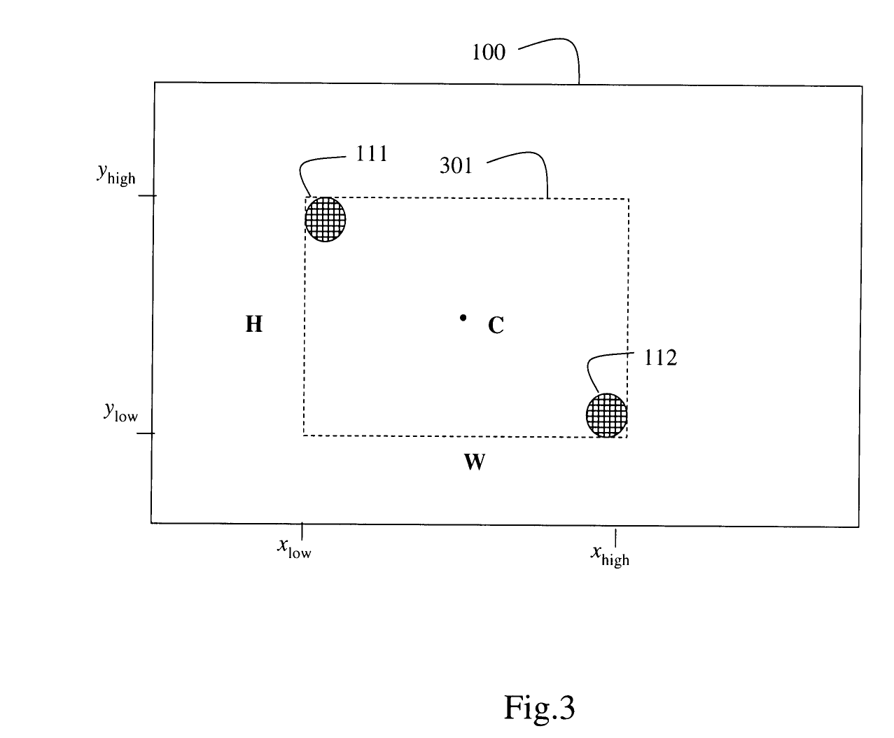

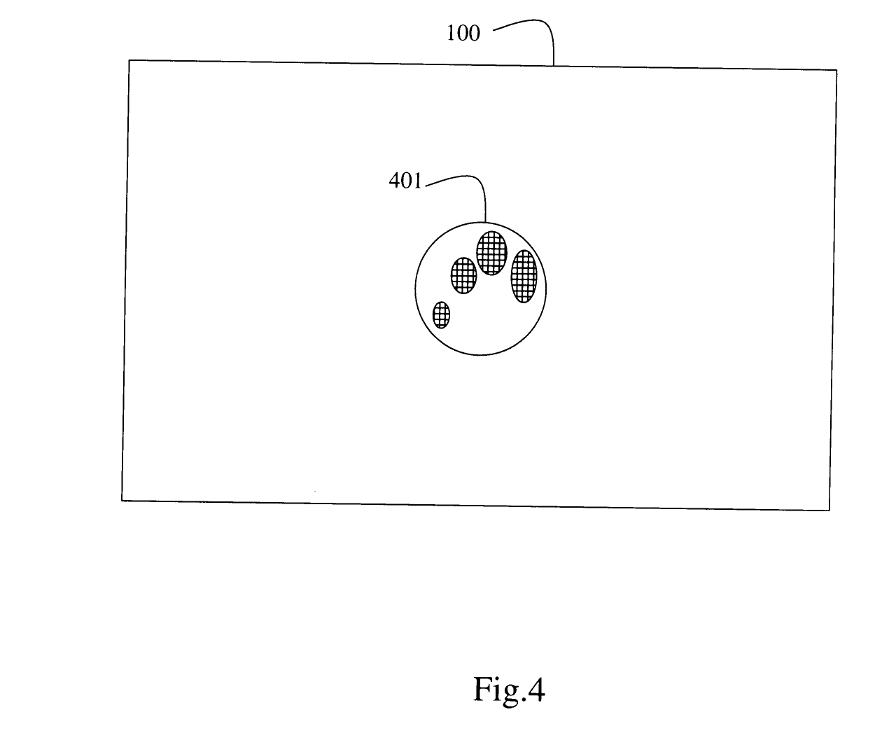

For example, as shown in FIG. 3, the frame summary is used to determine a bounding perimeter 301 when the gesture is made with two fingers 111-112. In the case, where the perimeter is a rectangle, the bounding rectangle extends from the global x_{low}, x_{high}, y_{low}, and y_{high} of the intensity values. The center (C), height (H), and width (W) of the bounding box are also determined. FIG. 4 shows a circle 401 for a four finger touch.

As shown in FIGS. 5-9 for an example tabletop publishing application, the gestures are used to arrange and lay-out documents for incorporation into a magazine or a web page. The action performed can include annotating displayed documents, erasing the annotations, selecting, copying, arranging, and piling documents. The documents are stored in a memory of a computer system, and are displayed onto the touch surface by a digital projector. For clarity of this description the documents are not shown. Again, it should be noted that the gestures here are but few examples of many possible gestures.

In FIG. 5, the gesture that is used to indicate a desire to annotate a displayed document is touching the document with any two fingers 501. Then, the gesture is continued by “writing” or “drawing” 502 with the other hand 503 using a finger or stylus. While writing, the other two fingers do not need remain on the document. The annotating stops when the finger or stylus 502 is lifted from the surface. During the writing, the display is updated to make it appear as if ink is flowing out of the end of the finger or stylus.

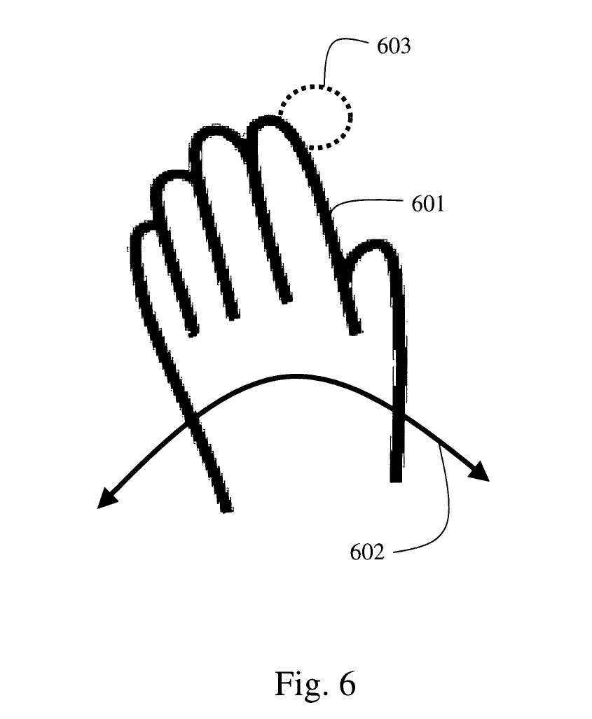

As shown in FIG. 6, portions of annotations can be “erased” by wiping the palm 601 back and forth 602 across on the surface. After, the initial classification of the gesture, any portion of the hand can be used to erase. For example, the palm of the hand can be lifted. A fingertip can be used to erase smaller portions. As visual feedback, a circle 603 is displayed to indicate to the user the extent of the erasing. While erasing, the underlying writing becomes increasingly transparent over time. This change can be on a function an amount of surface contact, speed of hand motion, or pressure. The less surface contact there is, the slower the change in transparency, and the less speed involved with the wiping motion, the longer it takes for material to disappear. The erasing terminates when all contact with the surface is removed.

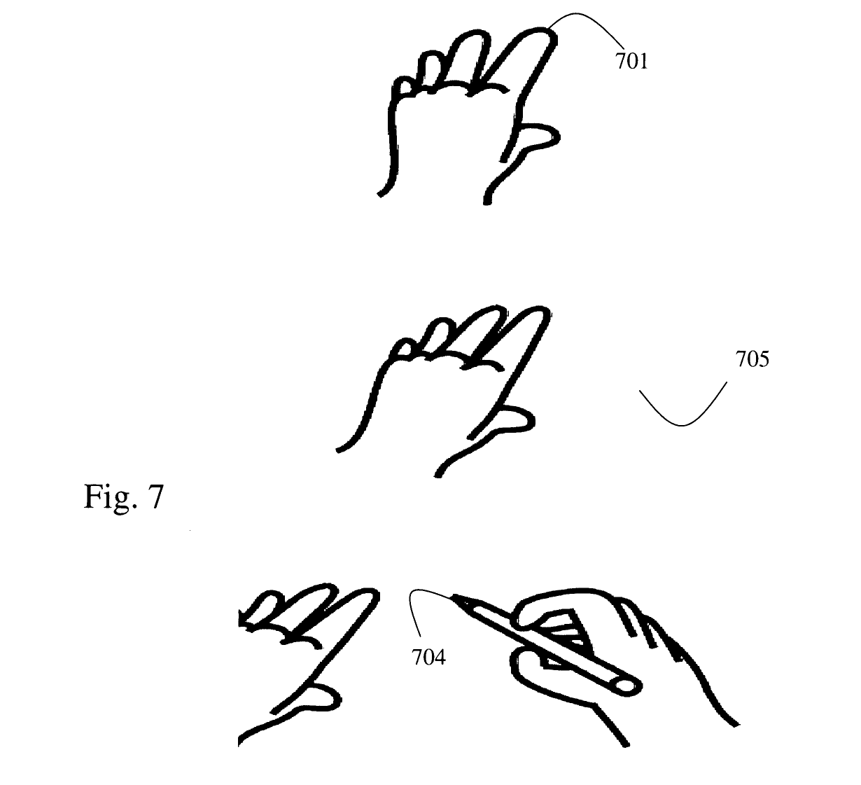

FIGS. 7-8 shows a cut-and-paste gesture that allows a user to copy all or part of a document to another document. This gesture is identified by touching a document 800 with three or more fingers 701. The system responds by displaying a rectangular selection box 801 sized according to the placement of the fingers. The sides of the selection box are aligned with the sides of the document. It should be realized that the hand could obscure part of the display.

Therefore, as shown in FIG. 8, the user is allowed to move 802 the hand in any direction 705 away from the document 800 while continuing to touch the table. At the same time, the size of the bounding box can be changed by expanding or shrinking of the spread of the fingers. The selection box 801 always remains within the boundaries of the document and does not extend beyond it. Thus, the selection is bounded by the document itself. This enables the user to move 802 the fingers relative to the selection box.

One can think of the fingers being in a control space that is associated with a virtual window 804 spatially related to the selection box 801. Although the selection box halts at an edge of the document 202, the virtual window 804 associated with the control space continues to move along with the fingers and is consequently repositioned. Thus, the user can control the selection box from a location remote from the displayed document. This solves the obstruction problem. Furthermore, the dimensions of the selection box continue to correspond to the positions of the fingers. This mode of operation is maintained even if the user uses only two fingers to manipulate the selection box. Fingers on both hands can also be used to move and size the selection box. Touching the surface with another finger or stylus 704 performs the copy. Lifting all fingers terminates the cut-and-paste.

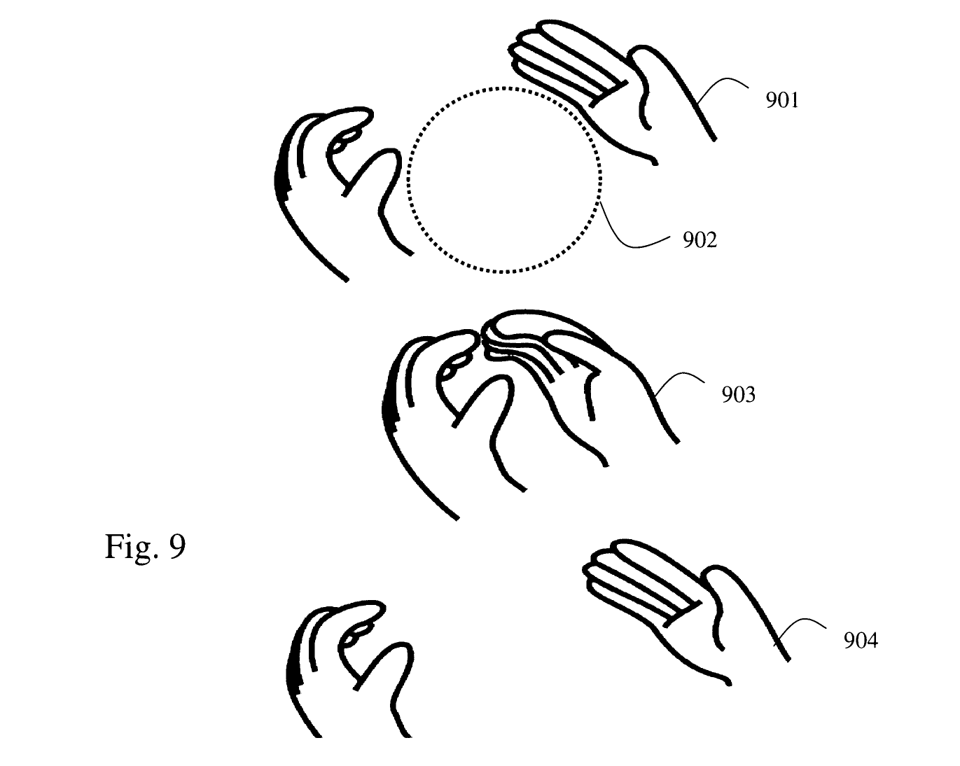

As shown in FIG. 9, two hands 901 are placed apart on the touch surface to indicate a piling gesture. When the hands are initially are placed on the surface, a circle 902 is displayed to indicate the scope of the piling action. If the center of a document lies within the circle, the document is included in the pile. Selected documents are highlighted. Positioning the hands far apart makes the circle larger. Any displayed documents within the circle hands are gathered into a ‘pile’ as the hands move 903 towers each other. A visual mark, labeled ‘pile’, can be displayed on the piled documents. After documents have been placed in a pile, the documents in the pile can be ‘dragged’ and ‘dropped’ as a unit by moving both hands, or single documents can be selected by one finger. Moving the hands apart 904 spreads a pile of documents out. Again, a circle is displayed to show the extent of the spreading. This operation terminates when the hands are lifted from the touch surface.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for recognizing hand gestures, comprising:
measuring an intensity of a signal at a plurality of touch sensitive pads of a touch sensitive surface;
determining a number of regions of contiguous pads touched simultaneously from the intensities of the signals;
determining an area of each region from the intensities; and
selecting a particular gesture according to the number of regions touched and the area of each region.

2. The method of claim 1, in which each pad is an antenna, and the signal intensity measures a capacitive coupling between the antenna and a user performing the touching.

3. The method of claim 1, in which the regions are touched simultaneously by a single user.

4. The method of claim 1, in which the regions are touched simultaneously by multiple users to indicate multiple gestures.

5. The method of claim 1, further comprising:
determining a total signal intensity for each region.

6. The method of claim 1, in which the total signal intensity is related to an amount of pressure associated with the touching.

7. The method of claim 1, in which the measuring is performed at a predetermined frame rate.

8. The method of claim 1, further comprising:
displaying a bounding perimeter corresponding to each region touched.

9. The method of claim 1, in which the perimeter is a rectangle.

10. The method of claim 1, in which the perimeter is a circle.

11. The method of claim 1, further comprising:
determining a trajectory of each touched regions over time.

12. The method of claim 11, further comprising:
classifying the gesture according to the trajectories.

13. The method of claim 11, in which the trajectory indicates a change in area size over time.

13. The method of claim 11, in which the trajectory indicates a change in total signal intensity for each area over time.

14. The method of claim 13, further comprising:
determining as rate of change of area size.

15. The method of claim 11, further comprising:
determining a speed of movement of each region from the trajectory.

16. The method of claim 15, further comprising:
determining a rate of change of speed of movement of each region.

17. The method of claim 8, in which the bounding perimeter corresponding to an area of region touched.

18. The method of claim 8, in which the bounding perimeter corresponding to a total signal intensity of the region touched.

19. The method of claim 1, in which the particular gesture is selected from the group consisting of one finger, two fingers, more than two fingers, one hand and two hands.

20. The method of claim 1, in which the particular gesture is used to manipulate a document displayed on the touch sensitive surface.

21. The method of claim 1, further comprising:
displaying a document on the touch surface;
annotating the document with annotations using one finger while pointing at the document with two fingers.

22. The method of claim 21, further comprising:
erasing the annotations by wiping an open hand back and forth across the annotations.

23. The method of claim 22, further comprising:
displaying a circle to indicate an extent of the erasing.

24. The method of claim 1, further comprising:
displaying a document on the touch surface;
defining a selection box on the document by pointing at the document with more than two fingers.

25. The method of claim 1, further comprising:
displaying a plurality of document on the touch surface;
gathering the plurality of documents into a displayed by placing two hands around the documents, and moving the two hands towards each other.

26. The method of claim 1, further comprising:
determining a location of each region.

27. The method of claim 26, in which the location is a center of the region.

28. The method of claim 26, in which the location is median of the intensities in the region.
